(19) United States
(12) Patent Application Publication
(10) Pub. No.: US 2001/0034639 A1
(43) Pub. Date: Oct. 25, 2001

(54) System and method for matching aggregated user experience data to a user profile

(76) Inventors: Jennifer B. Jacoby, New York, NY (US); Stephen I. Shapiro, Scarsdale, NY (US)

Correspondence Address: Marianne M. Downing, Esq., Mintz, Levin, Cohn, Ferris,, Glovsky and Popeo, P.C., One Financial Center, Boston, MA, 02111, US

(21) Appl. No.: 09/802,049

(22) Filed: Mar. 8, 2001

Related U.S. Application Data
(60) Provisional application No. 60/188,245, filed on Mar. 10, 2000.

(51) Int. Cl. G06F 17/60

(52) U.S. Cl. 705/10

(57) ABSTRACT

In one embodiment, the present invention provides a computer-assisted method for providing personalized product information to a user. A survey group comprising one or more members is defined and a personal information set relating to each member of the survey group, the personal information set comprising at least one variable relating to a personal characteristic of a member, is stored. A query set is sent over a computer network to the survey group, the query set comprising at least one question relating to the survey group's use of a product. Responses to the query set are received, over the computer network, from members of the survey group, and the responses are sorted based on the personal information set into a result set. The result set is stored at a central location. A user sends an inquiry over the computer network to the central location, the inquiry relating to information included in the query set. Data is selected from the result set based on at least one variable relating to a personal characteristic of the user. The selected data is then provided to the user.

This application claims priority from provisional application Ser. No. 60/188,245, filed Mar. 10, 2000.

### FIELD OF THE INVENTION

Embodiments of the present invention are directed to computer software and systems. More specifically, embodiments of the present invention are directed to computer-implemented systems and software for permitting users to obtain information about health products and services, where the information is based on the experiences of other people having a background or profile similar to the user.

### BACKGROUND OF THE INVENTION

Computer networks such as the Internet have dramatically changed the way the people communicate with each other and get information about topics that interest them. Tools such as electronic mail (e-mail) and instant messaging are rapidly eclipsing conventional printed and mailed communications, and on-line versions of publications such as newspapers and magazines expand the availability of information previously available only to a few. The Internet is also providing information (and ways of getting it) that has few equivalents in the non-Internet world. For example, search engines such as Yahoo and Lycos enable users to rapidly and instantly get huge quantities of information and data about virtually any topic of interest, such as travel destinations, a favorite entertainer, a potential employer, and the like. Other sources of information on the Internet include bulletin boards, chat groups, and newsgroups such as USENET. These latter information sources give everyone with access to the Internet a way to “speak out” to a virtually unlimited audience at any time and at little or no cost, providing useful information, wisdom, tips, tricks, questions and answers, running commentary, criticism, anecdotes, and more, directly from Internet users, on virtually any and every topic. In 1998, it was estimated that the equivalent of 360,000 pages of text is posted to USENET newsgroups in a twenty-four hour period—about the size of an encyclopedia.

To access the information in newsgroups such as USENET, sites such as www.altavista.com and www.deja.com provide search engines enabling users to search for posts directly related to specific topics. For example, a user can search a group such as alt.support.arthritis to view posts related to a topic such as “pain remedies.” Although it is sometimes possible to find information directly on topic, posted by others having a similar background (e.g., same age, gender, symptoms, etc.), one often has to sift through thousands of messages related to a given topic, reading each one, to determine if a post has personal relevance to a user. Another disadvantage is the prevalence of SPAM (unsolicited commercial email messages) and other advertisements disguised as “genuine” posts to such groups. Consequently, newsgroups are not a convenient or, more importantly, relevant source of information for many consumers, particularly health care consumers.

Some Internet and non-Internet businesses exist that attempt to better serve consumers seeking information to help them evaluate products and services. These companies include:

(1) “CareData” and “CareData.com,” a company on the healthcare payor/provider side that implements customer surveys and disseminates ratings on health plans;

(2) “J. D. Powers and Associates,” an organization that implements and disseminates customer satisfaction ratings on automobiles, airlines, etc.;

(3) “Zagat's” and “Zagats.com,” an organization that surveys restaurant-goers and publishes urban restaurant guides with food/price/ambience/service ratings and reviews (consisting of amalgamation of user quotations);

(4) “Healthgrades.com”, a site that offers directories and ratings on hospitals; nursing homes, physicians, health plans;

(5) “TheHealthPages.com,” a site that provides ratings on doctors, hospitals, dentists, managed care plans, mammography clinics, and maternity services;

(6) “Cnet.com,” which provides quantitative ratings (scale 1-5) on hardware and software-value, quality, reliability, features-and solicits quantitative comments; and

(7) “Deja.com,” which offers high level user ratings (only four parameters) on products/services within a wide range of categories (arts & entertainment automotive, computer and tech, consumer electronics, health and fitness, home and family, lifestyle, money, politics and media, recreation, sports, and travel). Within the health and fitness channel, Deja.com rates both products and services in the following categories: addiction, allergy, alternative, end of life, geriatrics, industry, long term care, media, men's health, mental, nutrition (diet aids and regimens, herbal supplements, and vitamins), pediatrics, physical conditions, prevention, sexual, surgery, and women's health. For consumer health products, Deja.com's four basic rating parameters are:

1. Effectiveness (rate 1-5)

2. Ease of use (rate 1-5)

3. Absence of side effects (rate 1-5)

4. Cost/benefit (rate 1-5)

### SUMMARY OF THE INVENTION

Despite the availability of services such as those described above, consumers of services and products relating to health care still do not currently have the ability to get personalized data relating to consumer health products and services. None of the services described above provides a personalized query capability (to enable a user to find personalized data) and none aggregates customer satisfaction, efficacy and side effect data on consumer health products and services in a way that provides more detailed and personalized information about these products and services, with the intent of disseminating that information back to consumers.

Another issue is the lack of clinical trial experience about many products and treatment regimens, particularly alternative medical treatments and products. Clinical trials are expensive and time consuming, and frequently such trials are performed on small subgroups of the population (e.g., white males between 40 and 50 years old). Consumers now try to solve the problem of the dearth of clinical information on consumer health products and services by asking colleagues, friends, and family members who had used the product about their individual experiences. By aggregating five or so user “anecdotes,” consumers would try to gauge whether or not the product would work for them. The limitations of this approach are described below.

Some researchers have attempted to address the dearth of information by performing limited clinical trials on these products. However, because most of these product markets are not large and proprietary enough to justify controlled clinical trials, the studies that have been done lack the scientific rigor of double-blind, placebo-controlled trials. Some businesses, such as Deja.com (described above) provide very general and high-level consumer ratings of consumer health products. The Deja.com ratings (on efficacy, ease-of use, absence of side effects, and cost/benefit) are (a) too general (they do not ask the right questions) and (b) not personalized. In particular, systems such as Deja.com lack the querying capabilities that are important to the present invention. These querying abilities, which are described in greater detail herein and illustrated herein in FIG. 2, permit users to access data that is most relevant to their specific situation.

Consumer health customers are interested in seeing supporting clinical data and/or actual user data (on efficacy and side effects) for the products and/or services that they are considering to treat and manage their conditions. As noted above, however, this type of data does not exist for most consumer health products and services. In the absence of this data, consumers often rely on descriptive materials on-line to learn more about the product, and anecdotal referrals from colleagues and family members to influence the purchase decision. This anecdotal data is limited, however, by the small sample size, failure to know and ask the right questions, and variations in individual experiences due to a range of variables (demographic differences, differing disease severity, presence of comorbid disease, length of time on treatment etc). These limitations make it difficult for an individual to extrapolate from anecdotes to assess how a consumer health product/service will work for them-in short what works for one person may not work for another. What consumers often want to know is how the product/service worked for people just like them (similar variable profiles). This sort of personalized data does not currently exist.

In one embodiment, the present invention applies the idea of aggregated, detailed customer satisfaction data to a new area—the evaluation of the performance of consumer products and/or services. In another embodiment, the invention exploits the interactive capabilities of the Internet to offer personalized queries of its database of information. Unlike existing customer satisfaction companies and/or market research firms presently providing aggregated ratings results, the present invention first aggregates data into a database of results, then permits users to “slice and dice” the database to view results for people like them (same age bracket, gender, condition, severity, smoker status, prior medical history, etc.).

In another embodiment, the invention permits health care professionals such as doctors and nurses to review the results and provide insight and commentary, if desired. The health care professionals also help to formulate and/or review the query sets used to create the database of information. In still another embodiment, other types of professionals such as statisticians can review, analyze, or edit the results. These types of reviews can help ensure that the data being accessed is as accurate, thorough, and relevant as possible, and help ensure that it is presented in a form usable by consumers. The characteristics of the Internet environment facilitate the development and maintenance of this dynamic longitudinal database and the real-time dissemination of this information in a personalized manner to individual users (through real-time database queries).

In one embodiment, the present invention provides a computer-assisted method for providing personalized product information to a user. A survey group comprising one or more members is defined and a personal information set relating to each member of the survey group, the personal information set comprising at least one variable relating to a personal characteristic of a member, is stored. A query set is sent over a computer network to the survey group, the query set comprising at least one question relating to the survey group's use of a product. Responses to the query set are received, over the computer network, from members of the survey group, and the responses are sorted based on the personal information set into a result set. The result set is stored at a central location.

A user sends an inquiry over the computer network to the central location, the inquiry relating to information included in the query set. Data is selected from the result set based on at least one variable relating to a personal characteristic of the user. The selected data is then provided to the user.

### BRIEF DESCRIPTION OF THE DRAWINGS

An understanding of the principles of the invention may be readily attained by reference to the following specification and the accompanying drawings in which:

FIG. 1 is an illustration of a computer system in which the present invention can be embodied;

FIGS. 2A-2B are a flow chart illustrating an interactive survey, in accordance with an embodiment of the invention;

FIGS. 3A-3D are illustrative representations of screen shots of a registration process and of the survey of FIGS. 2A-2B;

FIG. 4 is a flow chart illustrating the process for retrieving information that has been gathered in an interactive survey such as that illustrated in FIGS. 2A-2B; and

FIGS. 5A-5C are illustrative representations of screen shot for the process of FIG. 4.

The drawings are not necessarily to scale, emphasis instead generally being placed upon illustrating the principles of the invention.

### DETAILED DESCRIPTION OF THE PREFERRED EMBODIMENT

As used herein, the Internet refers to the worldwide collection of networks and gateways that use the transmission control protocol/Internet protocol (TCP/IP) suite of protocols to communicate with one another. The World Wide Web (WWW) refers to the total set of interlinked hypertext documents residing on hypertext transport protocol (HTTP) servers all around the world. As used herein, the WWW is also intended to refer to documents accessed on secure servers, such as HTTP servers (HTTPS), which provide for encryption and transmission through a secure port. WWW documents, referred to herein as web pages, can be written in hypertext markup language (HTML). As used herein, the term “web site” refers to one or more related HTML documents and associated files, scripts, and databases that is presented by an HTTP or HTTPS server on the WWW. The term “web browser” refers to software that lets a user view HTML documents and access files and software related to those documents.

As used herein, “consumer health product” and “consumer health service” refer to any product, service, or practice (including surgery) relating to maintaining, changing, or improving the health of a person, maintaining, treating, cleaning, or improving, any part or portion of the human body, and/or treating one or more conditions, ailments, sicknesses, and the like, where the product or service can include those prescribed or directed by a health care professional (e.g., prescribed or administered by a doctor) as well as those selected by the consumer herself (e.g., an over the counter product purchased by the consumer).

Thus, as used herein, “consumer health product” and “consumer health service” include, but are not limited to, pharmaceutical preparations (whether prescription or non-prescription); treatments (including cancer treatments); surgery and surgical treatments (including elective and non-elective surgery as well as procedures performed on an outpatient basis, such as laser skin treatments); acute and chronic care; injections; testing and/or monitoring products (including pregnancy tests, blood glucose test strips, blood pressure machines, blood glucose monitoring systems, etc.); regimes (including specific diets and weight control diets, products, and services); physical therapy; exercise, meditation, and hypnotism; “natural” and/or herbal remedies and products; products and services related to treating addictions of all kinds; homeopathic products and services; vitamins; supplements (including dietary supplements); alternative medicines and therapies (including acupuncture and Ayurvedic treatments); personal hygiene products; vision care products—in sum, virtually any product or service that a consumer or health care professional might consider using on or with any part of the human body.

In accordance with the descriptions of the invention provided herein, it should be understood that although the systems and method of the present invention have been heretofore described in relation to aggregating statistical data on user experiences with consumer health products and services, and matching a given individual's profile with relevant, aggregated user experience results, the invention is not intended to be limited to this type of application. Those skilled in the art will appreciate that the invention has applicability to virtually any type of situation where data is aggregated, especially where such data is collected directly from a those who later will have access to the data, where a match to a given set of data is to be found, and/or where data is analyzed and compared.

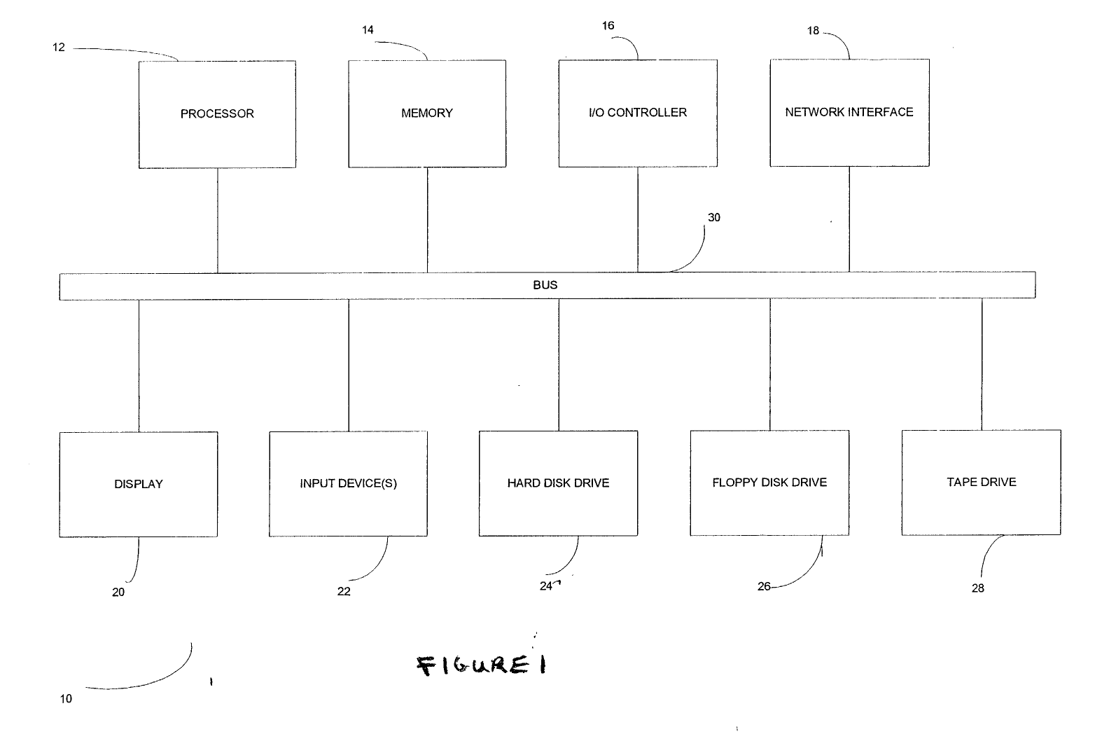

In one embodiment, the present invention comprises a computerized system implementing the aggregation and matching described herein. FIG. 1 is a simplified block diagram of a computer system 10 in which at least a portion of the system of the present invention can be embodied. The system 10 can be any type of general purpose computer system, such as a personal computer (PC), server, workstation, personal digital assistant (PDA), and the like, running any one of a variety of operating systems. In addition, software embodying the present invention may, in one embodiment, reside in an application running on the computer system 10. The present invention can also be embodied in a computer-readable program medium usable with a computer system such as the computer system 10.

Referring to FIG. 1, the computer system 10 typically includes a central processor 12, a main memory unit 14 for storing programs and/or data, an input/output controller 16, a network interface 18, a display device 20, one or more input devices 22, a fixed or hard disk drive unit 24, a floppy disk drive unit 26, a tape drive unit 28, and a data bus 30 coupling these components to allow communication therebetween.

The central processor 12 can be any type of microprocessor, such as a PENTIUM processor, made by Intel of Santa Clara, Calif. The display device 20 can be any type of display, such as a liquid crystal display (LCD), cathode ray tube display (CRT), light emitting diode (LED), and the like, capable of displaying, in whole or in part, the outputs generated in accordance with the systems and methods of the invention. The input device 22 can be any type of device capable of providing the inputs described herein, such as keyboards, numeric keypads, touch screens, pointing devices, switches, styluses, and light pens. The network interface 18 can be any type of a device, card, adapter, or connector that provides the computer system 10 with network access to a computer or other device, such as a printer. In one embodiment of the present invention, the network interface 18 enables the computer system 10 to connect to a computer network such as the Internet.

Those skilled in the art will appreciate that systems 10 embodying the present invention need not necessarily include every element shown in FIG. 1, and that equivalents to each of the elements are intended to be included within the spirit and scope of the invention. For example, not all computer systems 10 will include a tape drive 28, and some computer systems 10 might include other types of drives, such as compact disk read-only memory (CD-ROM) drives.

In one embodiment of the present invention, one or more computer programs define the operational capabilities of the computer system 10. These programs can be loaded into the computer system 10 in many ways, such as via the hard disk drive 24, the floppy disk drive 26, the tape drive 28, or the network interface 18. Alternatively, the programs can reside in a permanent memory portion (e.g., a read-only-memory (ROM)) chip) of the main memory 14. In another embodiment, the system 10 can include specially designed, dedicated, hard-wired electronic circuits that perform all functions described herein without the need for instructions from computer programs.

The computer system 10 can be part of a client-server system, in which a client sends requests to a server and a server responds to requests from a client. That is, the computer system 10 can be either a client system or a server system. The present invention typically is implemented at the server side and responds to requests made from a client.

The client can be broadly understood to mean any entity, such as a the computer system 10, or specific components thereof (e.g., terminal, personal computer, mainframe computer, workstation, hand-held device, electronic book, personal digital assistant, peripheral, etc.), or a software program running on a computer directly or indirectly connected or connectable in any known or later-developed manner to any type of computer network, such as the Internet. For example, a representative client is a personal computer that is x86-, PowerPC.RTM., PENTIUM-based, or RISC-based, that includes an operating system such as IBM.RTM. OS/2.RTM. or MICROSOFT WINDOWS (made by Microsoft Corporation of Redmond, Wash.),, and that includes a Web browser, such as MICROSOFT INTERNET EXPLORER, NETSCAPE NAVIGATOR (or higher) (made by Netscape Corporation, Mountain View, Calif.), having a Java Virtual Machine (JVM) and support for application plug-ins or helper applications. A client may also be a notebook computer, a handheld computing device (e.g., a PDA), an Internet appliance, a telephone, or any other such device connectable to the computer network.

The term “server” should also be broadly construed to mean an entity such as a computer, computer platform, an adjunct to a computer or platform, or any component thereof, such as a program, that can respond to requests from a client. Of course, a “client” can be broadly construed to mean one who requests or gets the file, and “server” can be broadly construed to be the entity that downloads the file. The server also may include a display supporting a graphical user interface (GUI) for management and administration, and an Application Programming Interface (API) that provides extensions to enable application developers to extend and/or customize the core functionality thereof through software programs including Common Gateway Interface (CGI) programs, plug-ins, servlets, active server pages, server side include (SSI) functions or the like.

The client and server can communicate using any system or transmission method capable of interconnecting two entities that are capable of communicating with each other, such as the Internet, an intranet, an extranet, or other computer networks. Networks can be land-based networks, wireless networks, and combinations thereof. Land-based networks include networks such as telephone lines, cable television lines, and direct physical connections. Wireless networks include networks that transmit information over the airwaves, such as cellular, satellite, microwave, packet radio, infrared line of sight, and spread spectrum technologies.

In accordance with one embodiment of the present invention, system 10 is implemented at a server providing, in response to client requests, processes for defining a user profile, receiving user-experience data from profiled users, aggregating received user-experience data into a searchable data set, and retrieving a customized data set from the searchable data set based on the user profile.

The present invention addresses the problems of the prior art by providing individuals with personalized, aggregated, detailed, user-experience data on consumer health products and services. In one embodiment, the present invention provides a web site, accessible using a web browser, that provides an accessible, personalized database of health related information. The database implemented in accordance with the invention addresses the limitations of anecdote information through:

(1) Aggregation of thousands of user experiences in a robust database, to address limited sample size and static perspective problems of anecdotes; and

(2) Personalized database queries to view user ratings results for people with a similar “profile” in terms of demographics, disease severity, medical history, etc, to address the problem of multiple “uncontrolled” variables in anecdotal referrals, by querying and/or slicing the database to control for a given set of profile variables.

In another embodiment, the present invention creates its database of information relating to consumer health products and services by directly questioning users about their conditions and the products, services, or treatment regimens that they used, and how well these regimens worked. These questions can be in the form of surveys or questionnaires. As noted above, the questions can be formulated by those having experience and/or knowledge about the product, service, disease, or condition, such as researchers, health care professionals, educators, and the like. The questions can be asked via any method capable of gathering the necessary information. Thus, for example, questions can be asked via interactive web pages, conventional written surveys mailed to a user, telephone surveys, electronic mail messages, facsimile, “in-person” questions (e.g., such as survey takers in a mall or supermarket), using touch tone keys of a telephone, etc. In one embodiment of the invention, each survey is intended to be highly-tailored to “ask the right” questions about a particular health care product or service, to gather information about specific aspects of product performance and side effects to enable meaningful evaluation.

In another embodiment, participants (i.e., those answering the questions) can improve upon and add to the questions by submitting comments. For example, suppose a survey is designed to ask users whether any one of five herbal supplements has any positive effects on insomnia. Based on the survey results, it is noted that a number of users are reporting that a particular herbal supplement that is NOT one of the original five does, in fact, have positive effects on their insomnia. This knowledge gleaned from the survey can be used to improve future versions of the survey. In this manner, the database and survey of the present invention are dynamic and are continually being refined, which improves its relevance for its users.

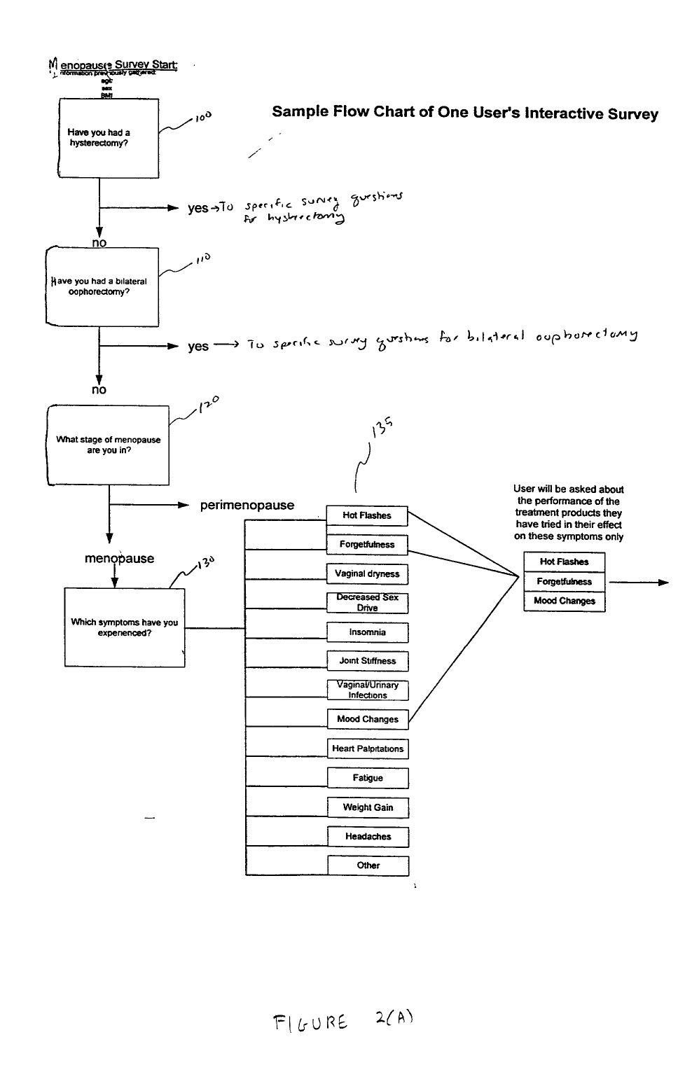

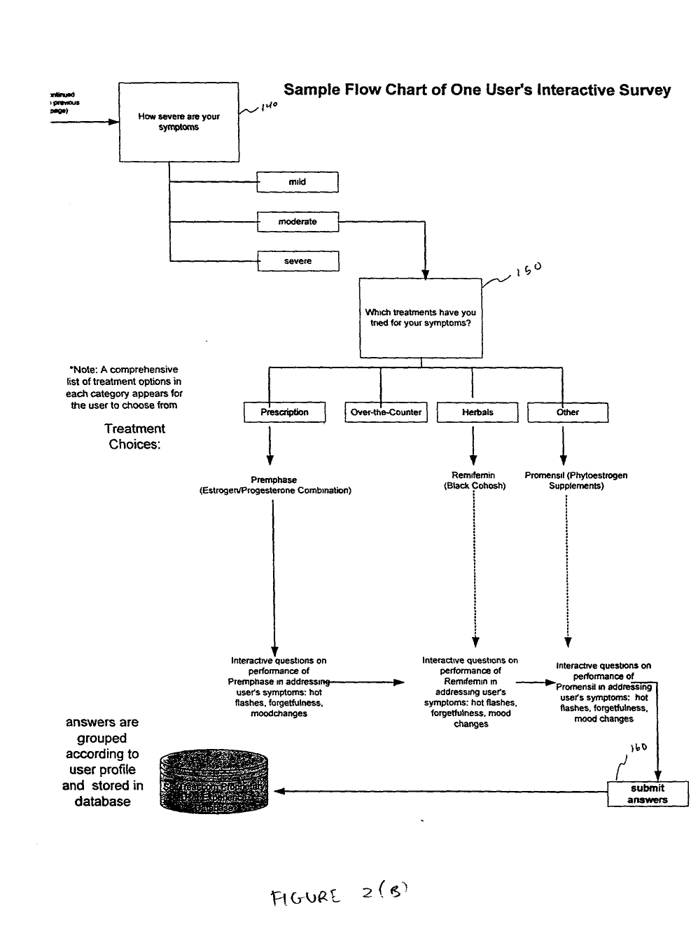

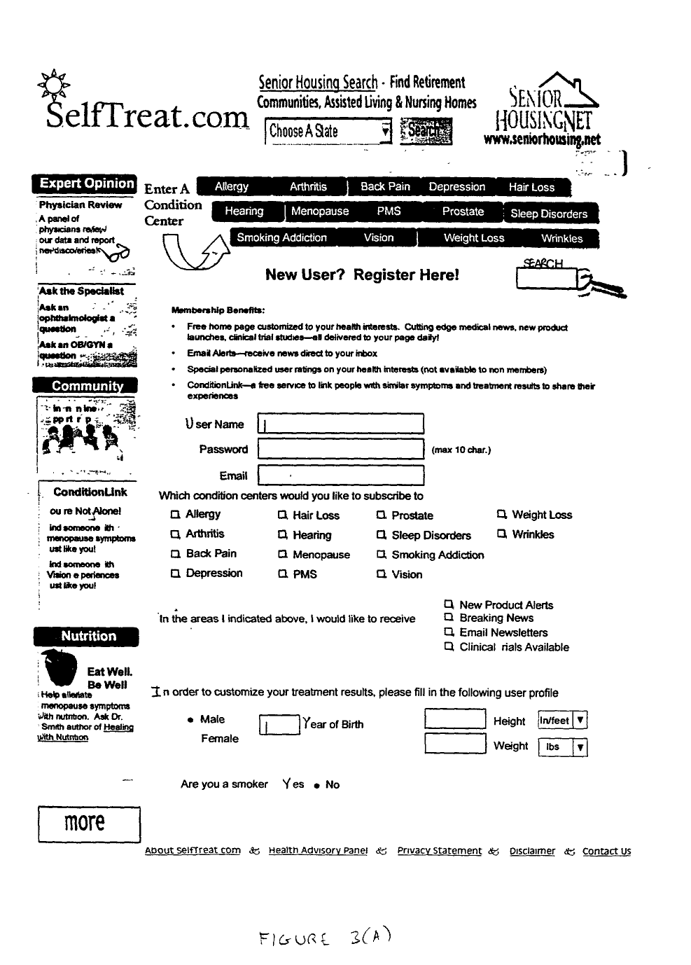

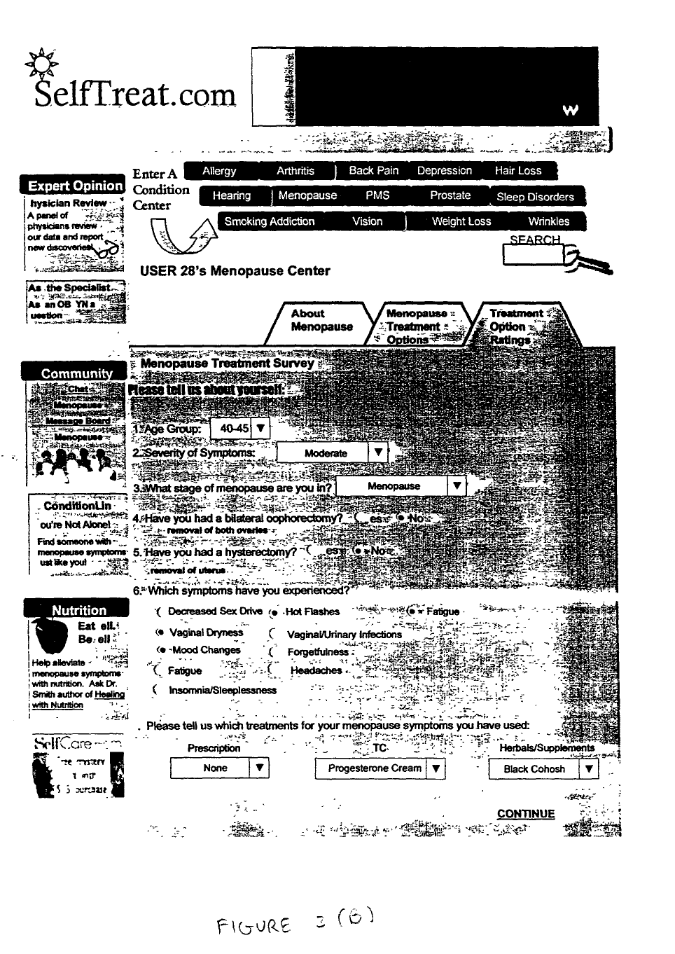

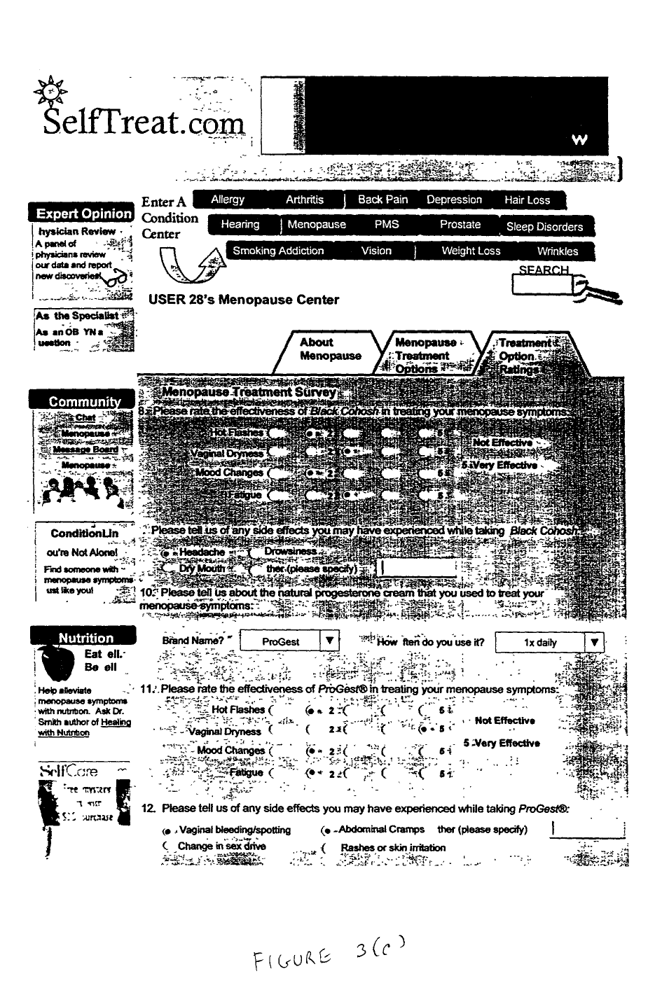

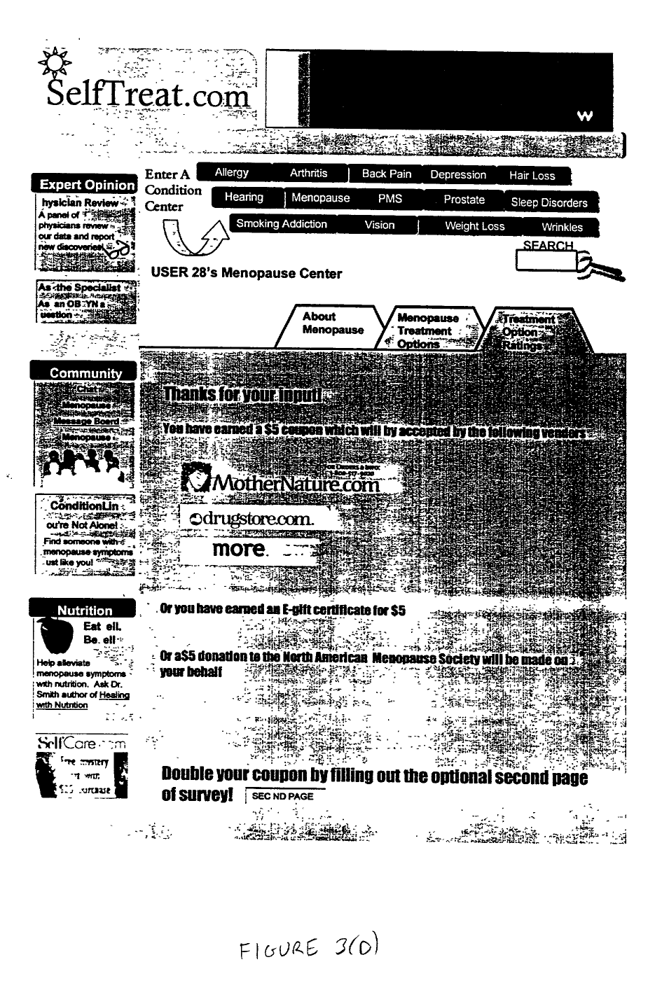

FIGS. 2A-2B are an example of a flow chart of the “decision tree” behind the survey illustrated in the representative screen shots of FIGS. 3A-3D, on accordance with one embodiment of the present invention. In FIGS. 2A-2B, all of the possible options at each question/step are not illustrated; rather, the tree illustrates the options that result based on the responses received from a particular user. It should be understood that the order, type, and breakdown of the questions of the flowchart/decision tree structure are not necessarily order-specific and are provided by way of example only. Those skilled in the art will recognize that similar types of decision tree structures can be presented for every question having more than one answer or having different issues relating to particular answers. In addition, those skilled in the art will recognize that different types of flow charts, state diagrams, flow diagrams, and the like, can illustrate the principles of the invention.

FIG. 3A is an illustrative screen shot of a representative set of questions for a new user enrolling onto the system of the present invention. The responses to questions such as those shown in the screen shot of FIG. 3A help the system to personalize other questions presented to the user in surveys and/or to personalize data provided to the user.

Referring to FIGS. 2A-3D, in response to question 1 (step 100), the user indicates that she has not had a hysterectomy. If she had indicated “Yes,” the interactive survey can be modified in ways that relate to that answer. For example, the additional questions could be part of a pop-up window, inserted immediately into the quiz, additional questions could be added to any part of the quiz, additional answer options could be added to existing questions, and the like. It should also be understood that all of the survey questions need not appear all at once in the manner illustrated in FIGS. 3A-3D. For example, questions could be shown one at a time. In another embodiment, the specific answer to a question might not necessarily result in changes to the survey, but would instead be another characteristic that would help the survey data be relevant for users. In this example, the user in this example has answered “No” to the first question (step 100) and to the second question (step 200), and has indicated in the third question (step 120) that she is in the “menopause” stage.

Based on the user's answers (step 135) to question 4 (step 130) relating to the symptoms she has experienced, the interactive survey of the invention dynamically modifies itself to ask the user about the performance of the treatment products she has tried as to their effect on those symptoms only. Referring to FIG. 1B, questions 5 (step 140) and 6 (step 150) permit the user to indicate the severity of the symptoms and the treatments that the user has tried. Although not illustrated in FIG. 1B, additional questions could then be asked that relate to the specific treatments that the user has tried. In addition, in accordance with another embodiment, as users indicate other treatments that they have used and their corresponding effects (or lack thereof) on their symptoms, future users who take the same quiz are given additional options/questions that reflect these additional experiences. Thus, the survey can grow “smarter” the more users take it.

The interactive survey of FIGS. 2A-3D need not be given solely on a computer, but can be given in any manner calculated to receive answers, such as over a telephone, via mailed surveys, in a magazine (with results mailed to one or more central locations), and the like. The survey also can be given using a combination of methods (e.g., part on the computer, part over a telephone). It should also be understood that not all surveys in accordance with the invention are required to be interactive type surveys. Thus, for non-interactive surveys, some methods of gathering data (such as mailing surveys) can be used.

In one embodiment of the invention, an incentive is provided for taking the survey. For example, FIG. 3D illustrates that the user is given an item or service having value, such as a gift certificate to an online business. Other suitable incentives will occur to those skilled in the art. In one embodiment, access to the database itself may be considered the “item or service having value,” and such continued access may be contingent on continued participation in surveys.

It also should be understood that the subject matter of the questionnaire of FIGS. 2A through 3D is provided by way of example only, and of course is not intended to limit the invention to the subject matter of menopause treatments. Those skilled in the art will recognize that many different types of questionnaires can be formulated about many different types of medical issues, such as symptoms, diseases, conditions, or any other topic.

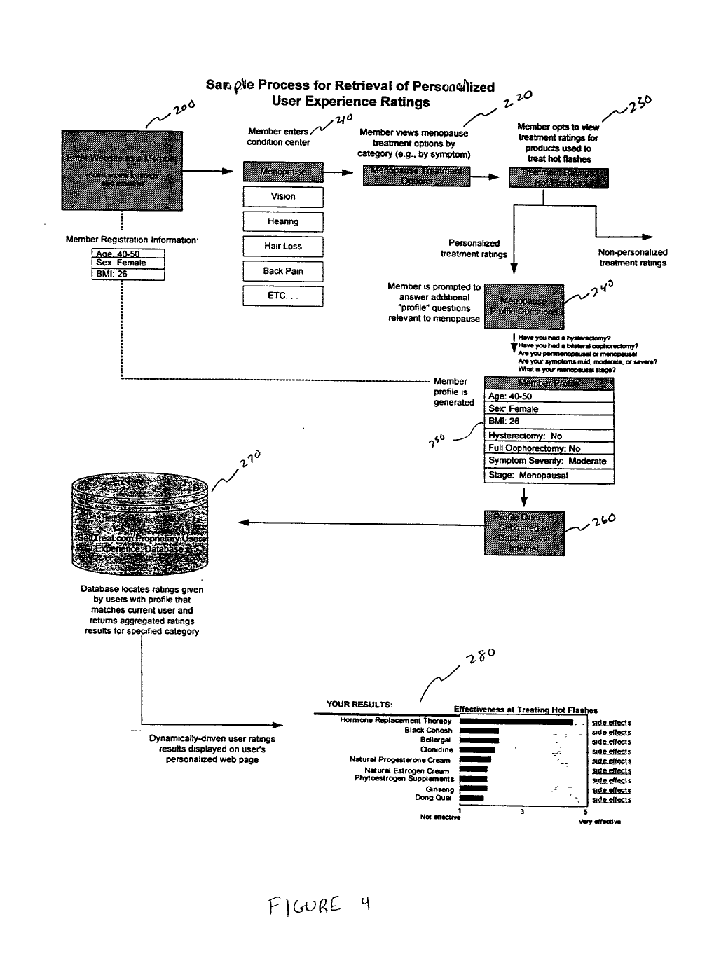

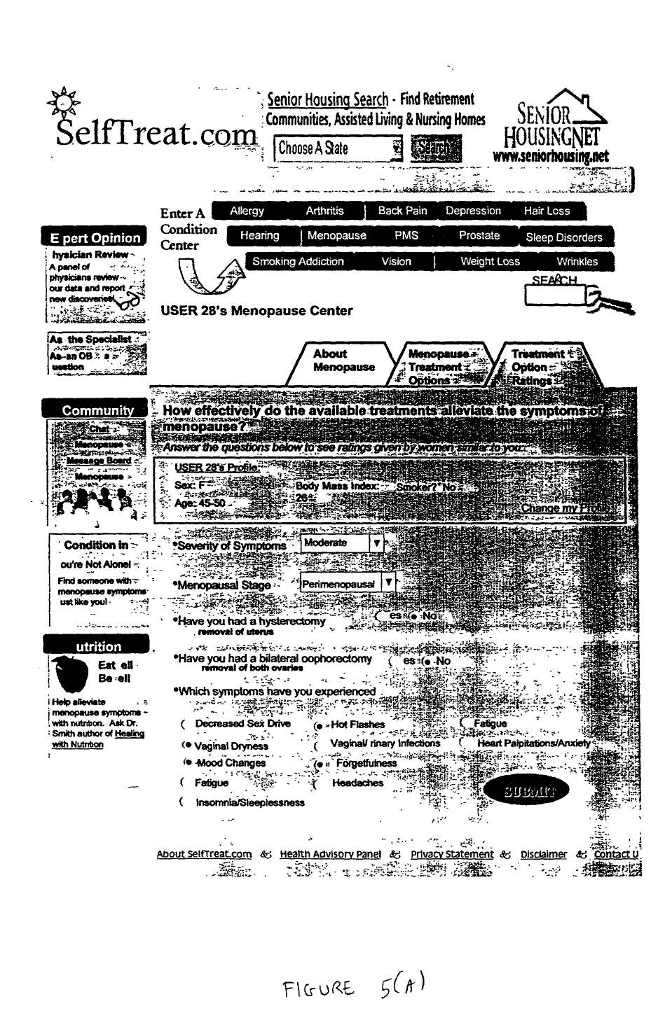

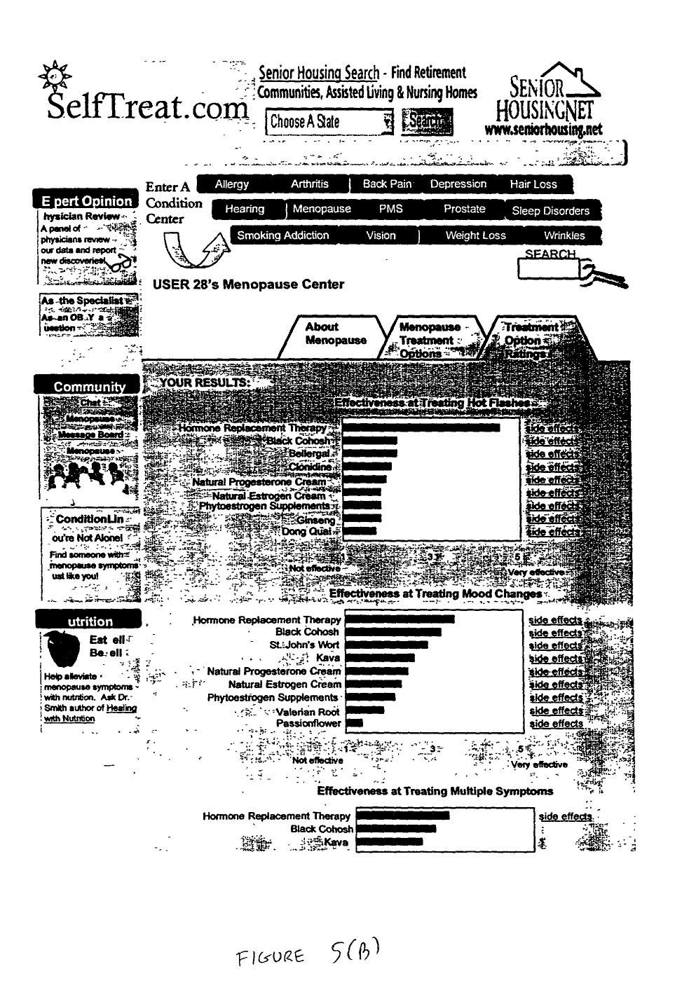

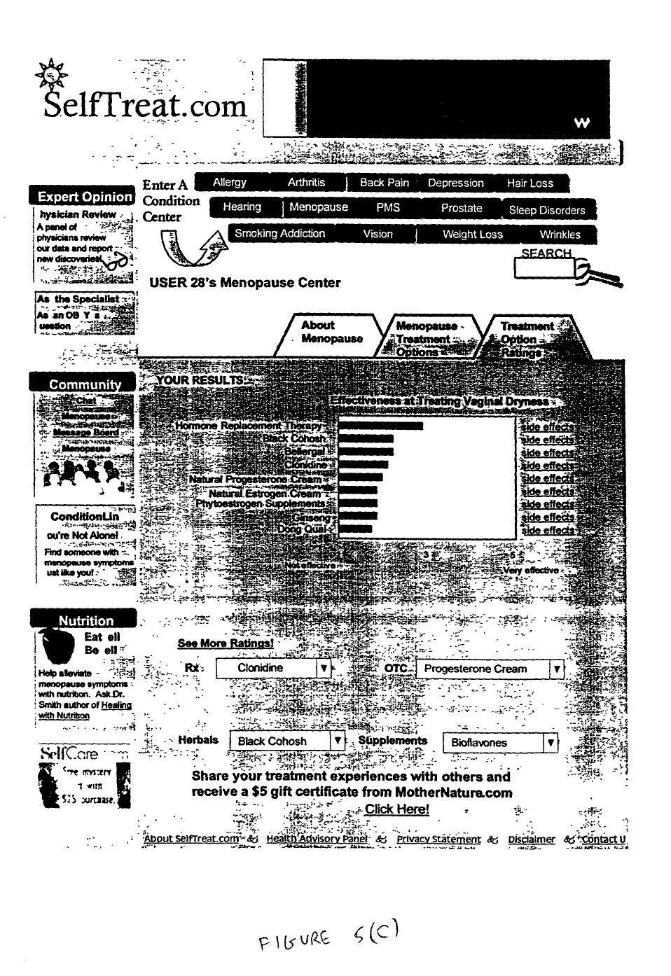

FIGS. 4 and 5A-5B illustrate how a user can retrieve and view results to determine how well a particular product or service might work for her. For example, the user can query the database to determine the type of menopause treatment that works best for 45 year old smokers who have had hysterectomies, which might be very different from the type of treatment that works for other women who have had hysterectomies but who are overweight 60 year old nonsmokers.

As each set of questions is completed and submitted to the system, the information is aggregated with information that has been provided by other users, both in response to the particular survey and in some instances in response to other surveys. Self reported ratings from thousands of consumers are aggregated in a dynamic, longitudinal, proprietary database. In some embodiments of the invention, the data can be reviewed to eliminate “junk” data, such as nonsensical data, data that is extremely unlikely to occur, or data that appears repeatedly under the exact same type of profile and might have been submitted by a marketer and not a real user. In one embodiment of the invention, the system performs such a review automatically. For example, the system can be programmed to reject multiple submissions from a particular email address. In another embodiment, trained personnel (such as statisticians and/or health care professionals) can review the data.

FIG. 4 is a flow chart illustrating a process in which a user can retrieve data about a particular condition and its treatment, and FIGS. 5A-5C also illustrate an embodiment of the invention that incorporates at least a portion of this process. In this example, the user is seeking information about menopause treatments. The user can enter (step 200) the website that incorporates the system as a member, can enter as a guest (which in some embodiments might limit the services and/or data that can be accessed), or can enroll onto the system to generate a member profile. Next, the user selects a condition for which she wants more information (step 210) and the particular treatment that interests her (steps 220 and 230). The user can, in this embodiment, select between personalized and non-personalized treatment ratings.

In another embodiment of the invention (not shown), an identifier capable of uniquely identifying a particular user can be used in connection with the user's computer to automatically provide data and other information personalized to the user. The identifier can be a “cookie,” a password (including conventional passwords and graphical passwords), a biometric authentifier (e.g., the results of a retinal eye scan, hand geometry reader, fingerprint, thumbprint, voice print, signature reader, and the like, a token (e.g., a “smart card”), or any other type of identifier known to those skilled in the art.

To further personalize the information provided to the user, in one embodiment of the invention, the system requests additional information from the user (step 240), such as additional “profile” or other questions related to the condition and/or treatment that she has selected. The results of these additional questions are combined with other information known about the user to generate a profile query (step 260), which is submitted over a computer network such as the Internet to a User Experience Database (step 270). In another embodiment of the present invention, the profile query of step 260 is generated based solely on either questions posed to the user or on the user profile.

When the query is submitted to the database, the database locates information relevant to the user by locating information related to the symptom or treatment that has been provided by other users having profiles that partially and/or substantially match the profile of the current user. In one embodiment, the degree of the match (e.g., a 40% match) can be provided to the current user along with the data returned. The data retrieved can then be displayed to the current user, such as on a personalized web page (step 280) (see FIGS. 5A-5B). Although not shown in the example, other information about the data presented (e.g., sample size, margin of error, average, mean, sample size associated with one or more questions, date range for the data and the like) can be presented to the user.

In another embodiment of the invention, the database is used as a basis for other information-based offerings to customers, both on-line and off line. For example, although the above-described surveys were directed towards the effectiveness of a particular treatment on symptoms of menopause, other questions in the survey have applicability to other topics of interest. For instance, a manufacturer, marketer, or market research firm interested in learning more about specific categories of users might want to determine how often such users (e.g., people at particular height, weight, and age) exercise, and this information might have been gathered in one or more existing surveys. In one embodiment of the invention, the database of information is searchable such that it is possible to access virtually any information available, whether or not it fits the questions in a particular survey. In one embodiment of the invention this feature might be limited to administrators of the system. In another embodiment, users can be permitted to conduct such queries.

In still another aspect, the system of the invention can use its surveys to aggregate user experiences about specific brands of similar products, and provide information to manufacturers in the form of “Detailed user experience reports.” These detailed user experience reports can provide specific sets of data of relevance to a particular manufacturer, such as: detailed demographic information about users of that manufacturer's brand; comparative demographic information for users of a specific manufacturer's brand vis-a-vis users of competing brands; detailed user experience information from users of the product in general or a specific manufacturer's brand (e.g. broken down by user demographics, dosage levels, or other interesting metrics); or comparative user experience information from users of a specific manufacturer's brand vis-a-vis users of competing brands. For example, a manufacturer of a product such as St. John's Wort might want to determine how its particular brand of product was rated by users in different demographic categories as improving symptoms of depression as compared to another brands of St. John's Wort manufactured by other manufacturers.

Those skilled in the art will recognize that many different types of tailored database queries could be performed for manufacturers, generating specific “slices” of data including but not limited to those listed above. These detailed information sets may or may not be provided to users of the system, but generally can be made available to manufacturers that participate. In one embodiment of the invention, the manufacturer can pay for the questions relating to its brand, can help pay for the “incentives” provided to participants in the survey, or can pay for customized “slices” of data in the form of “detailed user experience reports.” This type of data aggregation can benefit both manufacturers and consumers: manufacturers have information that they can use to improve the marketing of their products, improve the performance of their product and/or develop new products, and consumers improve their chances of locating and learning about products that will really benefit people like themselves.

In yet another embodiment of the invention, parties that provide consumer health care products and services can commission specific surveys and/or survey questions that relate to the products and/or services that they are selling and/or providing. For example, a manufacturer of a cold remedy might request that specific questions about its product be added to surveys that may be related or unrelated to relieving colds. The manufacturer could pay a fee for this service directly to the administrators of the system of the invention, or could even provide a gift certificate or coupon to users in return for answering the question(s). This helps providers of such products and/or services gather additional data about how their products work quicker and more inexpensively than offline marketing and/or clinical research. This information can also help providers learn additional ways in which their products are being used by consumers, which can be used in advertising and marketing as well as in promoting additional research.

In another embodiment of the invention, the data from the consumer ratings can be provided to marketers of services and products, both related to the health care industry and unrelated. For example, a marketer of a particular line of sports clothing for women might want to determine the segment of the population that comprises active exercisers and the approximate heights and weights of these women (to determine the sizes of product that might sell the best).

It should be understood, that the illustrative screen shots herein are provided by way of example only. Those skilled in the art will recognize that many different types of web sites, having many different types of “look and feel” qualities, are intended to be included within the scope of the invention. Those skilled in the art will recognize that many different types of systems and web pages can be designed in accordance with the invention.

Variations, modifications, and other implementations of what is described herein will occur to those of ordinary skill in the art without departing from the spirit and the scope of the invention as claimed. Accordingly, the invention is to be defined not only by the preceding illustrative descriptions and drawings but also from the claims.

What is claimed is:

1. A computer-assisted method for providing personalized product information to a user, comprising the steps of:
defining a survey group comprising at least one member;
storing a personal information set relating to each member of the survey group, the personal information set comprising at least one variable relating to a personal characteristic of a member;
sending a query set over a computer network to the survey group, the query set comprising at least one question relating to the survey group's use of a product;
receiving over the computer network responses to the query set from members of the survey group;
sorting the responses based on the personal information set into a result set and storing the result set at a central location;
receiving at the central location an inquiry sent over the computer network from a user, the inquiry relating to information included in the query set;
selecting data from the result set based on a variable relating to a personal characteristic of the user; and
providing the selected data to the user.

2. The method of claim 1 wherein the product comprises a medical product.

3. The method of claim 1 wherein the product comprises a service.

4. The method of claim 3 wherein the service relates to the provision of medical care.

5. The method of claim 1 wherein the user is a member of the survey group.

6. The method of claim 5 further comprising the step of selecting data from the result set based on at least one variable in the personal information set that is known about the user; and

7. The method of claim 1 wherein the step of selecting data further comprises sending a query over the computer network to the user relating to a personal characteristic of the user and receiving information from the user relating to the personal characteristic.
